(19) United States
(12) Patent Application Publication
(10) Pub. No.: US 2008/0109282 A1
(43) Pub. Date: May 8, 2008

(54) SYSTEMS AND METHODS FOR TRANSFERRING FUNDS FROM A SENDING ACCOUNT

(76) Inventor: Daniel Csoka, Schaumburg, IL (US)

Correspondence Address: STRATEGIC PATENTS P.C.., C/O PORTFOLIOIP, P.O. BOX 52050, MINNEAPOLIS, MN, 55402, US

(21) Appl. No.: 11/854,505

(22) Filed: Sep. 12, 2007

Related U.S. Application Data
(60) Provisional application No. 60/825,382, filed on Sep. 12, 2006.

(51) Int. Cl. G06Q 40/00; G06Q 10/00

(52) U.S. Cl. 705/7; 705/35; 705/44

(57) ABSTRACT

Provided herein are methods and systems for transferring funds from a sending account to a payee. In embodiments, the sending account may be a pre-paid wireless telephone account. The methods and systems may involve a transaction management system, an account setup module, a funds transfer module and a reporting module.

### CROSS-REFERENCE TO RELATED APPLICATIONS

This application claims the benefit of the following provisional applications, each of which is hereby incorporated by reference in its entirety:

U.S. Provisional Application No. 60/825,382, entitled “Systems and Methods for Transferring Funds from a Telephone Account” filed on Sep. 12, 2006.

### BACKGROUND

1. Field

The present invention relates to the field of transferring funds, and in particular, the present invention relates to systems and methods for transferring funds from a sending account to a payee.

2. Description of the Related Art

In recent years the number of individuals without a bank account has been growing and these individuals require a means for transferring money to other individuals as transactions involving cash may not always be feasible. The prevalence of mobile phones and like devices has seen a similar increase and pre-paid mobile phones are often used by individuals without a bank account. The present invention relates to systems and methods by which accounts related to mobile phones and the like can be used to allow individuals, including individuals without bank accounts, to easily transfer funds.

### SUMMARY

The present invention relates to systems and methods for transferring funds from a sending account to a payee. In embodiments, funds may be deposited in the sending account and the sending account may be a pre-paid wireless telephone account, a pre-paid telephone account, a pre-paid wireless account, a pre-paid land-line telephone account, a pre-paid calling card, a pre-paid stored value card, a post-paid wireless telephone account, a post-paid land-line telephone account or the like. A transaction may be initiated, facilitated and/or completed by one or more of a sender, receiver and host. A transaction may involve verification. In embodiments, a payee may be associated with a sending account in advance of a transaction.

The systems and methods described herein may involve one or more of a transaction management system, at least one database, a payor system, a payee system, at least one receiving system, at least one bank associated with at least one receiving system, at least one carrier system, at least one bank associated with at least one carrier system, at least one network, a processor, a display device, an input device, memory, at least one storage device, and a network interface. The systems and methods described herein may involve an account setup module, a funds transfer module, a reporting module, and an account management module.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 is a schematic diagram illustrating a system for transferring funds according to one embodiment of the invention.

FIG. 2 is a flow diagram of a transaction from the viewpoint of a sender.

FIG. 3 is a flow diagram of a transaction from the viewpoint of a receiver.

FIG. 4 is a flow diagram of a transaction facilitated by a host.

FIG. 5 is a flow diagram of transaction verification.

FIG. 6 is a flow diagram of a process for transferring funds to a payee.

FIG. 7 is a schematic diagram illustrating a system for transferring funds according to one embodiment of the invention.

FIG. 8 is a schematic diagram illustrating a transaction management system according to one embodiment of the invention.

FIG. 9 is a flow diagram of an account setup module according to one embodiment of the invention.

FIG. 10 is a flow diagram of a funds transfer module according to one embodiment of the invention.

FIG. 11 is a schematic diagram illustrating a system for associating a payee with a payor's sending account according to one embodiment of the invention.

FIG. 12 is a flow diagram of a reporting module according to one embodiment of the invention.

FIG. 13 depicts an overall conceptual architecture of a system for transferring funds.

### DETAILED DESCRIPTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Various embodiments of the present invention provide systems and methods for transferring funds from a sending account to a payee. Throughout, the sending account may be one or more of a pre-paid wireless telephone account, a pre-paid telephone account, a sending account, a pre-paid land-line telephone account, a pre-paid calling card, a pre-paid stored value card (which may or may not be associated with a mobile phone), a post-paid wireless telephone account, a post-paid land-line telephone account, a credit card account, a debit card account and the like. Throughout, the sending account may be associated with a mobile phone, a landline, a stored value card and the like.

Currently, users of pre-paid wireless telephones deposit funds into a sending account maintained by a wireless telephone carrier (e.g., Cingular, Verizon, Nextel, or the like), and these funds may be used to make wireless telephone calls or purchase digital media (e.g., ring tones and the like) using the wireless telephone. In embodiments, funds may be directly deposited in the sending account. The funds may be deposited when airtime is purchased. In embodiments, the directly deposited funds may be used for at least one of remittance, and to purchase good and services. In various embodiments of the present invention, sending account holders may be provided the ability to transfer funds from their sending accounts to another person or entity. For example, a sending account holder in Georgia may transfer $200 to his family in Arizona or his friend in Cancun, Mexico using various embodiments of the present system.

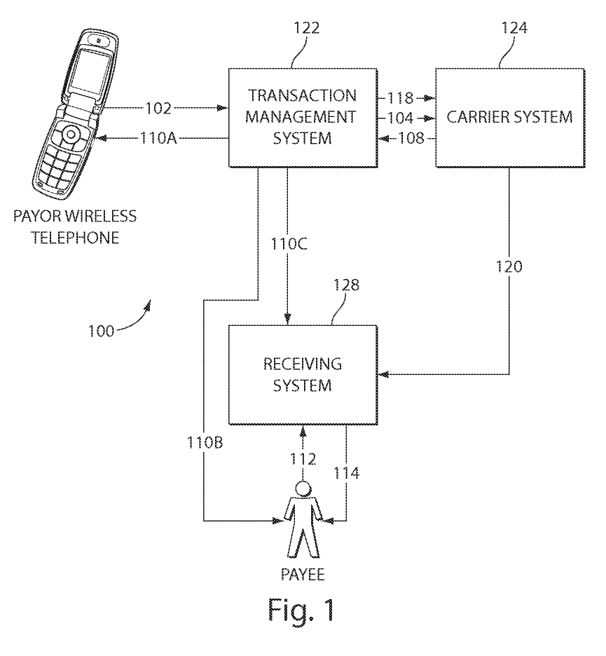

FIG. 1 illustrates a schematic diagram of the funds transfer process according to various embodiments of the invention. In particular, the funds transfer process 100 begins with a sending account holder (herein referred to as “payor”) generating a request to transfer funds to a payee from the sending account, shown as Step 102. According to one embodiment, the request includes a phone number associated with the payor's pre-paid wireless telephone, a value of funds to be transferred, and an identification of a payee (or a payee's bank) to receive the funds. In one embodiment, for example, the request may be generated by the payor calling an interactive voice response (IVR) system using the payor's pre-paid wireless telephone or another telephone. Throughout, in certain embodiments, an IVR system may translate spoken words into text and may input the text into a system, such as the Transaction Management System 122. Throughout, in certain embodiments, the translation performed by the IVR system may be provided to a user (such as in the form of a text message, email, and the like) and the user may be given an opportunity to review and verify the translation. Throughout, the IVR system may record the name of a payor, payee and/or unique identifiers (such as a social security number, voter registration number, government issued number and the like) related to a person or entity, including without limitation, the payor and payee.

According to various embodiments, the Transaction Management System 122 receives the request and verifies with the carrier system 124, indicated by Step 104, that: (1) the phone number is a valid phone number and is associated with a sending account held by the carrier; (2) the identification of the payee has been associated with the payor's sending account; and (3) the amount of funds requested does not exceed the available balance in the payor's sending account. In certain embodiments, the verification may include verification that the identification of the payee has been linked with the payor's sending account and verification that the identification of the payee has not been associated with the payor's sending account. The carrier system 124 may then generate and send a response, indicated by Step 108, confirming the phone number is valid, the payee has been associated with the sending account, and the funds do not exceed the available balance in the sending account. If the phone number is invalid, the payee has not been associated with the sending account, or the funds requested exceed the available balance of the sending account, the request to transfer funds may be denied. In certain embodiments, the identification of the payee may be provided only at the time of retrieval of the funds. In certain embodiments, the relevant carrier may be provided prior to performing verification with the carrier system 124.

The Transaction Management System 122 may receive the response from the carrier system 124 and generate and send a transaction number to the payor, payee, and a receiving system 128 associated with the payee, indicated by Steps 110A, 110B, and 110C, respectively. Throughout, the transaction number may consist of at least one of a transaction identification number and a password. Throughout, the transaction number may consist of 19 alphanumeric digits. Throughout, the password may consist of 10 alphanumeric digits. Throughout, the transaction number may remain the same for a payor across transactions, and the password may change across transactions. Throughout, the password may remain the same and the transaction number may change across transactions. Throughout, the transaction number may be provided via at least one of email, text message, voicemail, instant message, multimedia message, data message, and audio message.

The receiving system 128, according to various embodiments, may be, for example, a merchant, a merchant's bank, a payee's bank, a wireless telephone carrier with whom the payee has an account (e.g., pre-paid or post-paid), the carrier's bank, or the like. To obtain the funds, the payee may present the transaction number to the receiving system 128, indicated by Step 112, and the receiving system 128 may verify the transaction number and amount of funds to be received by the payee. If the transaction number presented by the payee is verified by the receiving system 128, the receiving system 128 may provide the funds requested to the payee, indicated by Step 114. In certain embodiments, the payor may be notified when the payee has received the funds. The notification may be provided via at least one of email, text message, voicemail, instant message, multimedia message, data message, and audio message.

According to various embodiments of the invention, settlement between the receiving system 128 and the carrier system 124 may occur periodically for authorized transactions that may have occurred within a particular time period (e.g., real time, hourly, daily, every 48 hours, every 90 days, every 180 days, weekly, or the like). In one embodiment, the Transaction Management System 122 may consolidate the settlement requests for each carrier system 124 into a batch file and transmit each batch file to the respective carrier system 124, indicated by Step 118. Upon receiving the settlement request, according to various embodiments, a bank associated with the carrier system 124 may transfer the funds in the settlement request to a bank associated with each respective receiving system 128 via the banking network 708 or another network (e.g., automated clearing house (ACH), electronic funds transfer (EFT), or the like), indicated by Step 120. In other embodiments, the carrier system 124 may transfer the funds in a settlement request to each respective receiving system 128 via a check, money order, or other payment instrument. In certain embodiments, the funds provided to the payee may be cleared through a clearing bank. The funds provided to the payee may be transferred from a bank associated with the carrier system 124 to a clearing bank which then transfers the funds to a bank associated with the receiving system 128. The method may enable funding of a plurality of payees. In embodiments, a separate transaction number may be generated for each payee. Throughout, the funds provided to the payee may be less than the amount of funds sent by the payor. Throughout, a payee may elect to receive less than the full amount of the funds sent by the payor. The excess funds may be returned and/or collected by the payee at a later time. Throughout, in embodiments, fees may be collected so that the amount received by the payee is less than the amount sent by the payor.

Throughout, in embodiments, a compliance assessment may be performed at, prior to or after the time funds are transferred and/or provided to a payee. Throughout, in embodiments, a compliance assessment may be performed at, or prior to or after the time a transaction is approved. Throughout, in embodiments, a compliance assessment may be performed at, prior to or after the time a payee is associated with a sending account. In embodiments, a compliance assessment may involve compliance with and/or assessing compliance with federal, state, local, international and other law, rules and/or regulations. In embodiments, a compliance assessment may involve reviewing and/or determining volume and/or velocity. In embodiments, a compliance assessment may involve assessing compliance with volume and/or velocity controls, regulations and the like. Volume many include how much money is transferred in a transaction. Velocity may include how often money is transferred. In embodiments, a compliance assessment may be preformed in order to satisfy at least one of the Financial Crimes Enforcement Network, the Office of Foreign Assets Control, a Treasury department or government branch, a labor department or government branch, a justice department of government branch, a federal trade commission and the like. In embodiments, a compliance assessment may be preformed in order to assess compliance with at least one of the following acts and regulations Title 18, USC 1956, Title 18, USC 1957, Title 18, USC 1960, Bank Secrecy Act, Anti-Money Laundering Act, Counter Terrorist Financing Act, Know Your Customer Act, The Patriot Act, similar domestic and foreign laws and the like.

In embodiments, a compliance assessment, possibly in connection with the reporting module 1200, may also generate suspicious activity reports. In embodiments, sending multiple transactions with each transaction amount being close to the maximum permitted transaction amount may be deemed suspicious and a report generated. A report may be generated, even if the maximum total funds allowed to be transferred in the period is not exceeded. In embodiments, compliance assessment may be performed in real time, periodically, at the time of registration, at the time of association of a payee and sending account, at the time of a transaction and the like.

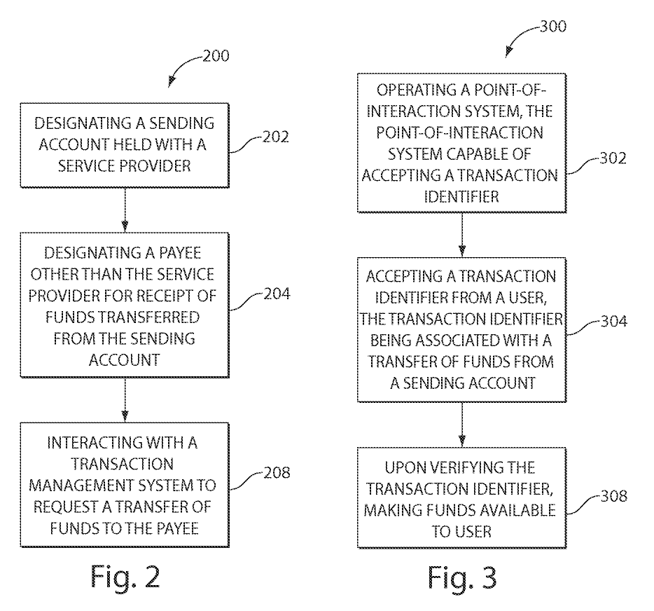

In an embodiment, a transaction may be directed from the viewpoint of a sender. Referring to FIG. 2, a sending account held with a service provider may be designated 202. A payee other than the service provider for receipt of funds transferred from the sending account may be designated 204. There may be an interaction with a Transaction Management System 122 to request a transfer of funds to the payee 208. In an embodiment, the interaction with the Transaction Management System 122 may include confirming the desire to transfer funds to the payee. In an embodiment, the Transaction Management System 122, upon confirmation, may generate a transaction number to be used by the payee to obtain funds at a point of interaction. In an embodiment, interacting with the Transaction Management System 122 may include entering a password.

In an embodiment, a transaction may be directed from the viewpoint of a receiver. Referring to FIG. 3, a method of providing funds to a user may involve operating a point-of-interaction system which may be capable of accepting a transaction identifier 302. The transaction identifier may be accepted from a user and may be associated with a transfer of funds from a sending account 304. Upon verifying the transaction identifier, the funds may be made available to the user 308. In an embodiment, making funds available to the user may include at least one of providing cash to the user, adding airtime to a phone account, paying a bill for the user and providing an item, and the like, such as a stored value card, to the user in exchange for the available funds. In an embodiment, the point-of-interaction may be a point of sale system or a point of purchase system.

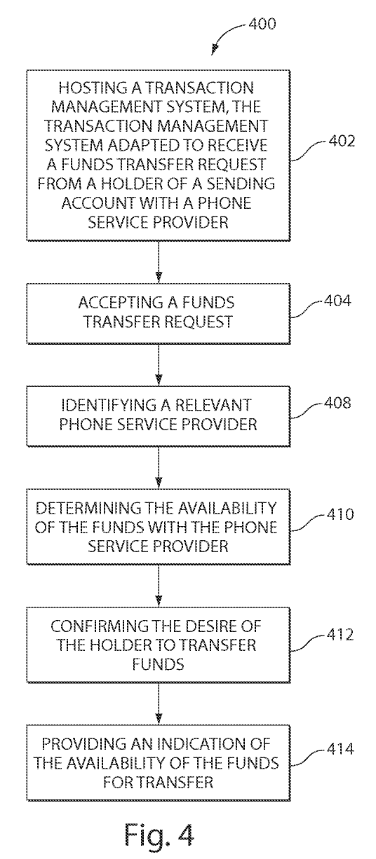

In an embodiment, a transaction may be facilitated by a host. Referring to FIG. 4, a method of facilitating a transaction may involve hosting a Transaction Management System 122 that is adapted to receive a funds transfer request from a holder of a sending account with a phone service provider 402. A funds transfer request may be accepted 404 and a relevant phone service provider may be identified 408. The availability of the funds with the phone service provider may be determined 410. The desire of the holder to transfer funds may be confirmed 412 and an indication of the availability of the funds for the transfer may be provided 414. In an embodiment, an indication of the availability of the funds for the transfer 414 may include providing an indication to a point-of-interaction operator. In an embodiment, the point-of-interaction operator may operate at least one of a point-of-sale system and a point-of-purchase system. In an embodiment, providing an indication of the availability of the funds for the transfer 414 may include providing a transaction number to a payee that is adapted to be submitted by the payee to the point-of-interaction operator.

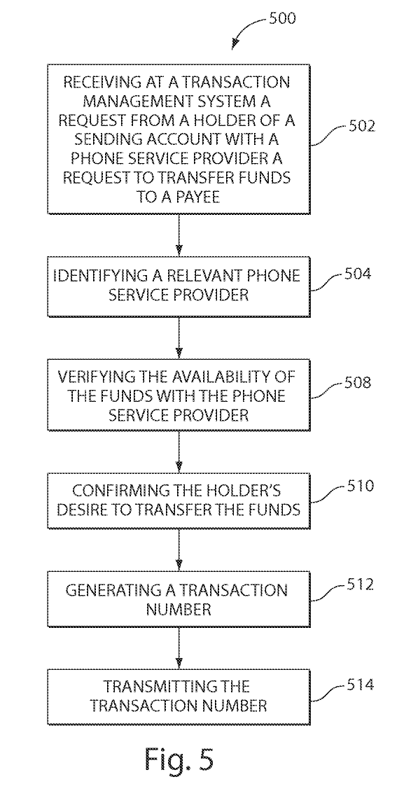

In an embodiment, a transaction may be verified. Referring to FIG. 5, a method of verification may involve receiving at a Transaction Management System 122 a request from a holder of a sending account with a phone service provider to transfer funds to a payee 502. A relevant phone service provider may be identified 504 and the availability of the funds may be verified with the phone service provider 508. The holder's desire to transfer the funds may be confirmed 510 and a transaction number generated 512 and transmitted 514. In an embodiment, the method may further involve providing funds to the payee that are cleared through a clearing bank. In an embodiment, the method may further involve providing funds to the payee that are transferred from a bank associated with the phone service provider to a clearing bank which then transfers the funds to a bank associated with a receiving system 128. In an embodiment, the transaction number may be transmitted to a payee, who relays the transaction number at a point-of-interaction to a party equipped with a point-of-interaction system, upon which the party may make the funds available to the payee. In an embodiment, the transaction number may consist of at least one of a transaction identification number and a password. The transaction number may be 19 alphanumeric digits and the password may be 10 alphanumeric digits. In a certain embodiment, the transaction number may remain the same for a payor across transactions and the password may change across transactions. In another embodiment, the password may remain the same and the transaction number may change across transactions. In an embodiment, the transaction number may be provided via at least one of email, text message, voicemail, instant message, multimedia message, data message, audio message, and the like.

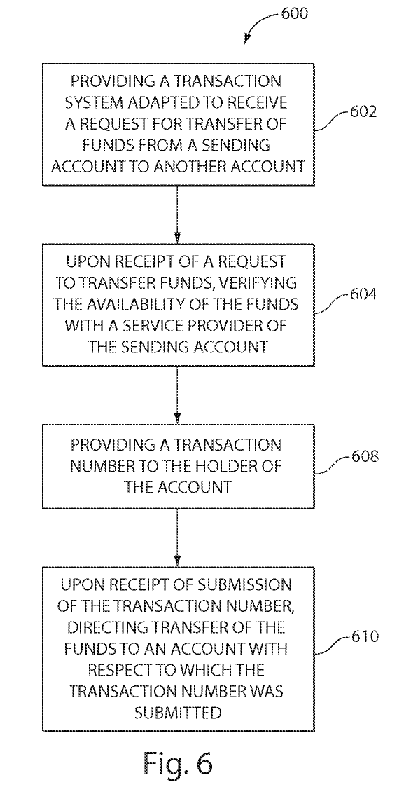

In another embodiment, a method may be provided for transferring funds to a second payee or account. Referring to FIG. 6, the method may involve providing a transaction system adapted to receive a request for transfer of funds from a sending account to another account 602. Upon receipt of the request to transfer funds, the availability of the funds may be verified with the service provider of the sending account 604. A transaction number may then be provided to the holder of the account 608. Upon receipt of the submission of the transaction number, the transfer of the funds may be directed to an account with respect to which the transaction number was submitted 610. In certain embodiments, the method may further include processing a request to transfer funds to the payee from the sending account and, in response to the request being approved, transmitting a transaction message to the payee. The transaction message may be presentable by the payee to a receiving system 128 in order to collect the funds included in the request. In certain embodiments, the method may further comprise the step of generating a settlement request for the sending account to transmit funds to the receiving system 128. In an embodiment, the sending account may be associated with a payor. In an embodiment, the sending account may be identified by a phone number associated with a pre-paid wireless telephone. In an embodiment the sending account may be identified by a device identification of a pre-paid wireless telephone. In an embodiment, the funds may be transmitted from a receiving bank. In certain embodiments, the method may further include notifying the payor when payee has received the funds. The notification may be provided via email, text message, voicemail, instant message, multimedia message, data message, audio message and the like.

In an embodiment, a system for processing a request to associate a payee with a sending account of a payor and a request to transfer funds to the payee from the sending account may be provided. The request to associate the payee with the sending account and the request to transfer funds to the payee may be received over a communication network 708. The communication network 708 may be a wireless network 708, another network, the Internet, a banking network 708 or another network, a private communication network 708, a virtual private network 708, a landline, a proprietary communication network 708 and the like.

Throughout, a payee may become associated with a sending account prior to a transaction, after a transaction, during the course of and/or as a result of a transaction. In certain embodiments, a payee may become associated with a sending account prior to a transaction at the request of the payor. For example, a payor may provide a Transaction Management System 122 with at least one of the name and a unique identifier (such as social security number, voter registration number, government issued identification number and the like) which may then like the payee to the sending account. In certain embodiments, compliance assessment, as described herein, may be conducted at this time. In certain embodiments, a payee may become associated with a sending account prior to a transaction at the request of the payee. For example, a payee may provide identifying information to the Transaction Management System 122 which may then send a request to the payor. If the payor accepts, the payee may then be associated with the sending account. In certain embodiments, compliance assessment, as described herein, may be conducted at this time. In certain embodiments, a payee may become associated with a sending account at the time or immediately prior to the time that funds are retrieved by the payee. In certain embodiments, compliance assessment, as described herein, may be conducted at this time.

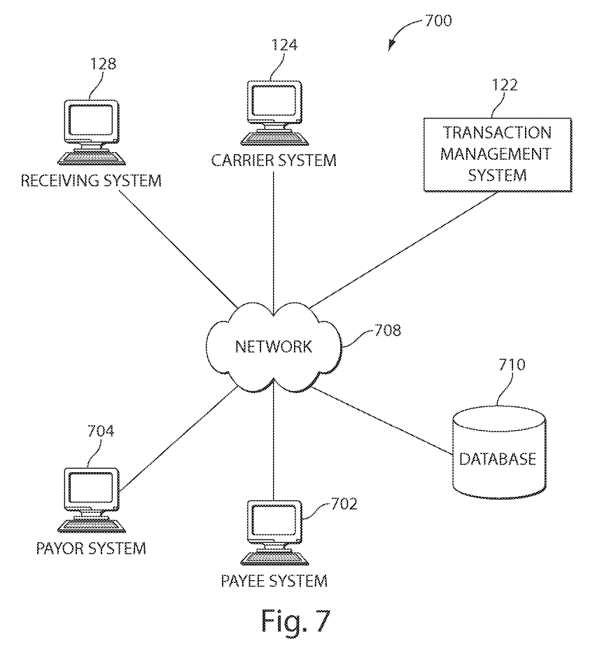

A system 700 according to one embodiment of the invention is shown in FIG. 7. As may be understood from this figure, in this embodiment, the system includes one or more payor systems 704, at least one receiver system 128 computer, and at least one carrier system 124 computer that are connected, via one or more networks 708 to communicate with a Transaction Management System 122. In embodiments, the network 708 may be a wireless network 708, another network, the Internet, a banking network 708 or another network, a private communication network 708, a virtual private network 708, a landline, a proprietary communication network 708 and the like. For example, in a particular embodiment, the one or more payor systems 704 communicate with the Transaction Management System 122 over one or more wireless networks 708 (e.g., cellular); the carrier system 124 communicates with the Transaction Management System 122 over the Internet (e.g., via TCP/IP sessions); and the receiving system 128 communicates with the Transaction Management System 122 over the banking network 708 or another network. In various other embodiments of the invention, communication between the Transaction Management System 122 and the carrier system 124, receiver system 128, and the one or more payor systems 704 may occur via a wireless network 708, another network, the Internet, or a private (or proprietary) communication network 708. In embodiments, the system 700 may further include one or more of an interactive voice response facility, an application programming interface for at least one carrier system 124, an application programming interface for at least one receiving system 128, a clearing bank and a clearing system.

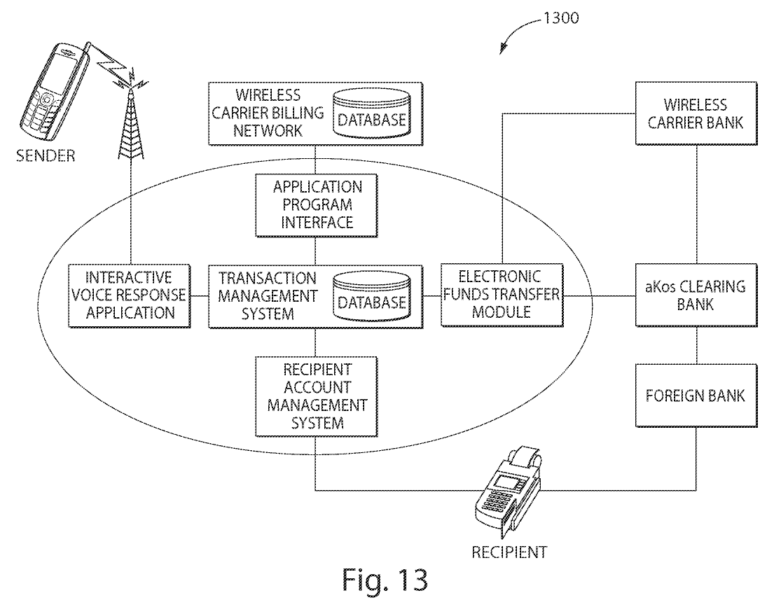

In one embodiment of the invention, the Transaction Management System 122 may be configured for retrieving data from, and storing data to, a database 710 that may be stored on (or, alternatively, stored remotely from) the Transaction Management System 122. In an alternative embodiment, the system 700 may include more than one database 710 (e.g., SQL database, Oracle database, or the like). In other embodiments, the Transaction Management System 122 may be one or more computers or software programs running on one or more computers. In addition, in one embodiment, the Transaction Management System 122 may be one or more computers or software programs running on the carrier system 124 computer. A conceptual architecture of an alternative embodiment of the invention is depicted in FIG. 13. An application programming interface may be associated with the recipient account management system.

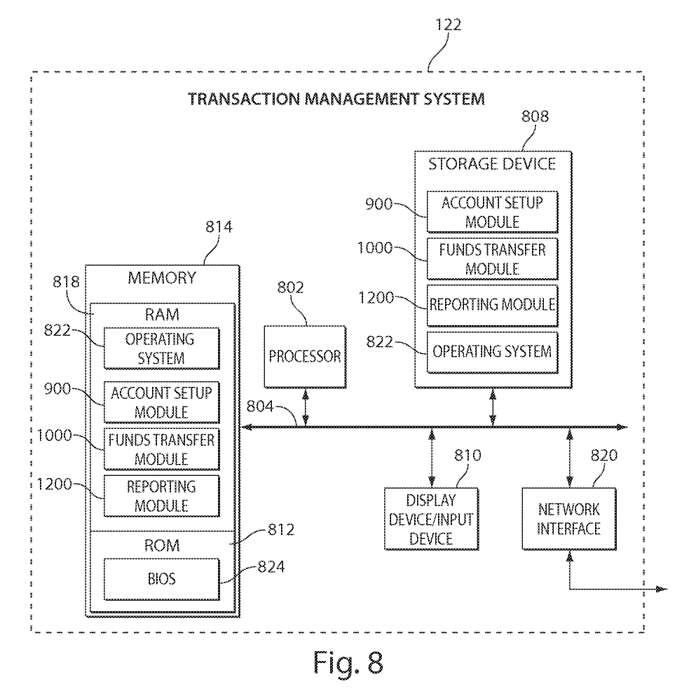

FIG. 8 shows a schematic diagram of a Transaction Management System 122 according to one embodiment of the invention. The Transaction Management System 122 may include a processor 802 that communicates with other elements within the computer system 122 via a system interface or bus 804. Also included in the system 122 may be a display device/input device 810 for receiving and displaying data. This display device/input device 810 may be, for example, a keyboard or pointing device that may be used in combination with a monitor. The system 122 further includes memory 814, which preferably includes both read only memory (ROM) 812 and random access memory (RAM) 818. The system's ROM 812 may be used to store a basic input/output system 824 (BIOS), containing the basic routines that help to transfer information between elements within the system 122. In embodiments, the memory 814 may store program modules selected from the group consisting of an operating system 822, an account set-up module 900, a funds transfer module 1000, a reporting module 1200, at least one carrier application programming interface, at least one financial institution application programming interface, an electronic funds transfer module and an automated clearing house module. Alternatively, the Transaction Management System 122 may operate on one computer or on multiple computers that may be networked together.

In addition, the system 122 may include at least one storage device 808, such as a hard disk drive, a floppy disk drive, a CD Rom drive, or optical disk drive, or the like, for storing information on various computer-readable media, such as a hard disk, a removable magnetic disk, or a CD-ROM disk, or the like. As will be appreciated by one of ordinary skill in the art, each of these storage devices 808 may be connected to the system bus 804 by an appropriate interface. The storage devices 808 and their associated computer-readable media may provide nonvolatile storage for a personal computer. It is important to note that the computer-readable media described above may be replaced by any other type of computer-readable media known in the art. Such media may include, for example, magnetic cassettes, flash memory cards, digital video disks, Bernoulli cartridges, and the like.

A number of program modules may be stored by the various storage devices and within RAM 67. For example, as shown in FIG. 8, program modules of the Transaction Management System 122 may include an operating system 822, an account setup module 900, a funds transfer module 1000, a reporting module 1200, and the like. In certain embodiments, the Transaction Management System 122 may further include an account management module. The account management module may be resident in memory 814 and/or stored on the storage device 808. The account setup module 900, the funds transfer module 1000, and the reporting module 1200 may control certain aspects of the operation of the Transaction Management System 122, as is described in more detail below, with the assistance of the processor 802 and an operating system 822.

Also located within the system 122 may be a network interface 820, for interfacing and communicating with other elements of a computer network 708. It will be appreciated by one of ordinary skill in the art that one or more of the system's 122 components may be located geographically remotely from other system 122 components. Furthermore, one or more of the components may be combined, and additional components performing functions described herein may be included in the systems 122.

As mentioned above, the system 700 according to various embodiments may enable a customer having a pre-paid wireless telephone and an associated sending account with a wireless carrier to transfer funds from the sending account to a payee. According to a particular embodiment, one or more potential payees may be associated with a sending account prior to the payor requesting that funds be transferred to the payees. By having each payee's information pre-associated with the sending account, the process of requesting and transferring funds to the payees may be less time-consuming for the payor and the Transaction Management System 122 and may provide security validation for the payor and the Transaction Management System 122. According to one embodiment, the account setup module 900 of the Transaction Management System 122 may associate at least one payee with a sending account prior to a funds transfer request being made, and the funds transfer module 1000 of the Transaction Management System 122 may process requests to transfer funds from the sending account to the payee. The reporting module 1200 of the Transaction Management System 122 may provide reports and/or access to financial data stored on the Transaction Management System 122 that may be used by the carrier system 124 and/or the receiving system 128 to reconcile transactions processed through the Transaction Management System 122. Various embodiments of each module are described below.

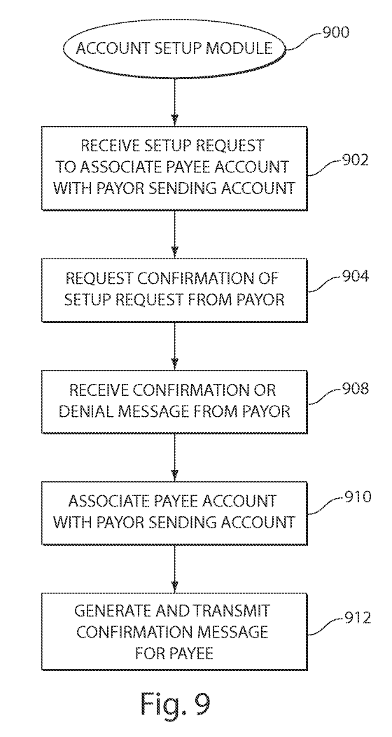

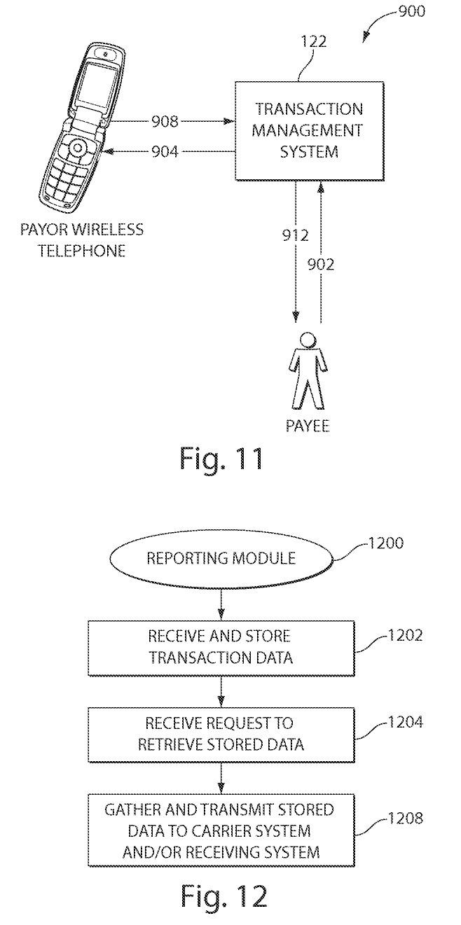

According to various embodiments of the invention, FIG. 9 illustrates a flow diagram of an account setup module 900, and FIG. 11 is a schematic diagram illustrating a system for associating a payee with a payor's sending account. Beginning at Step 902, the account setup module 900 may receive a setup request to associate a payee's account with a sending account of a payor. According to various embodiments, the setup request may include an identification of the payee, a receiving system 128 that may distribute the funds to the payee, an identification of the payor's sending account (e.g., phone number associated with payor's sending account or device identification associated with payor's pre-paid wireless telephone), and the like. For example, in one embodiment, the payee's identification may include the payee's name, address, country-specific identification number (e.g., social security number in the U.S.), passport number, and/or a nickname assigned by the payor (e.g., if the payee prefers to remain anonymous). In addition, the receiving system 128 may be one or more entities that are designated to receive funds from the carrier system 124 and distribute the funds to the payee. For example, the receiving system 128 may be a merchant system (and/or bank of the merchant), a wireless telephone carrier system 124 (and/or a bank of the wireless carrier), a bank system of the payee, and/or the like. In other various embodiments, the setup request may further include instructions regarding how the funds should be delivered (e.g., via ACH, EFT, or a payment instrument) to the receiving system 128 at settlement.

In various embodiments, the payee may generate the setup request using the payee's wireless telephone, a text message (e.g., SMS), a multi-media message (e.g., MMS), a wireless application protocol session (e.g., WAP), a downloadable graphical user interface, a data message, an audio message, a landline, a point of sale terminal, email, the Internet, and/or the like, and transmitted to the Transaction Management System 122 over a wireless network 708, another network and/or the like. In another embodiment, the setup request may be received by an interactive voice response (IVR) system that is in communication with the Transaction Management System 122. And, in various other embodiments, the setup request may be submitted through a kiosk, landline, email, IVR system, a computer, point-of-sale device, wireless network 708, another network, the internet and/or the like. In a certain embodiment, the setup request may be submitted at a merchant location using at least one of a wireless network 708, another network, the Internet, a kiosk, landline, email, IVR system, a computer, a point of sale device, and the like. In a certain embodiment, the setup request may be submitted at a bank location using at least one of a wireless network 708, another network, the Internet, a kiosk, landline, email, IVR system, a computer, a point of sale device, and the like. In an embodiment, the setup request may be submitted through the receiving system 128, which may be in communication over a network 708 with the Transaction Management System 122. Although the above embodiments describe the setup request as being generated by the payee or an agent of the payee (e.g., merchant clerk or other person designated by the payee to make the request), in various other embodiments, the payor may generate the setup request.

Next, in Step 904, the account setup module 900 may request confirmation of the setup request from the payor. In particular, according to various embodiments, the account setup module 900 may generate and transmit a message to the payor (e.g., via the payor's pre-paid wireless telephone or computer system) requesting the payor to confirm that the payee should be associated with the payor's sending account. According to various embodiments, the message may take the form of a text message, multi-media message, a data message, or an audio message, or the like, for example.

If the payor agrees that the payee may be associated with the payor's sending account, the payor may send a message to the account setup module 900 indicating confirmation. However, if the payor does not want the payee to be associated with the payor's sending account, the payor may send a message indicating a denial. The confirmation or denial message may be received by the account setup module 900 in Step 908.

In response to receiving a confirmation message from the payor indicating that the payee may be associated with the payor's sending account, the account setup module 900 in Step 910 may associate the payee with the payor's sending account, such as, for example, by storing data from the setup request in the database 710 with data identifying the payor's sending account (e.g., phone number or device identification associated with the payor's pre-paid wireless telephone). In various embodiments, this information may be stored in a memory on the Transaction Management System 122 or on the carrier's system 124.

Upon associating the payee with payor's sending account, the account setup module 900 may generate and transmit a confirmation message to the payee confirming that the payee has been associated with the payor's sending account, shown as Step 912.

In another embodiment, an account setup method may involve providing an account setup module that associates at least one payee with a sending account prior to a funds transfer request being made and associating the setup module with a Transaction Management System 122. The Transaction Management System 122 may be adapted to receive instructions from a holder of a sending account to direct funds to a third party. In an embodiment, the sending account may be a pre-paid wireless telephone account and/or a pre-paid telephone account.

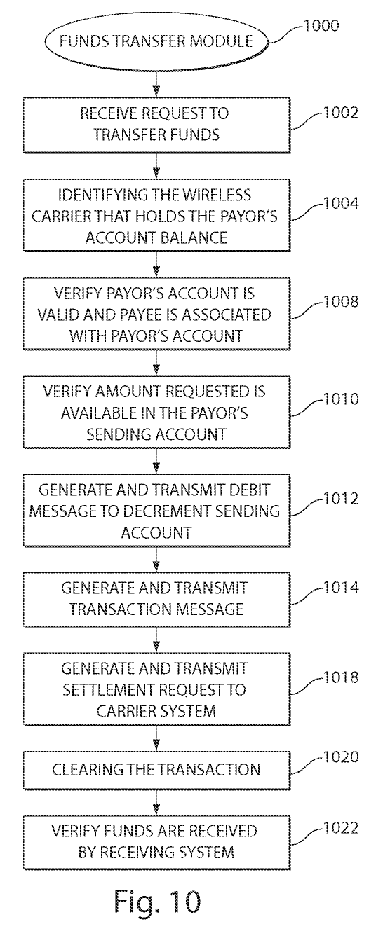

FIG. 10 illustrates a flow diagram of a funds transfer module 1000 according to various embodiments of the invention. Beginning at Step 1002, the funds transfer module 1000 may receive a request from the payor to transfer funds to a payee from the sending account of a payor. According to various embodiments, the request to transfer funds may include the identity of the payor's sending account (e.g., phone number or device identification associated with the payor's pre-paid wireless telephone) and an amount of funds to be transferred. In a further embodiment, the transfer request may also include an identity of the payee (e.g., account number of the payee, payee name, number associated with the payee, payee nickname, or the like). In addition, in one embodiment, the funds transfer request may further include information specifying the receiving system 128 that is to received the funds from the carrier system 124 and distribute the funds to the payee.

According to various embodiments, the request may be generated by the payor calling an IVR system using the payor's pre-paid wireless telephone. In another embodiment, the request may be generated by the payor (or an agent of the payor) calling the IVR system from another telephone and entering a personal identification number (PIN) or the like to verify that the payor (or the payor's agent) has permission to request transfers from the payor's sending account. In other various embodiments, the request may be generated by the payor creating a text message (e.g., short message service (“SMS”)), multi-media message (e.g., multi-media messaging service (“MMS”)), a wireless application protocol session (e.g., WAP), a downloadable graphical user interface, data message, or other messaging service using the payor's pre-paid wireless telephone. In yet another embodiment, the request may be created using email or submitting information over the Internet (e.g., via HTML, XML) or other communication network 708. In another embodiment, an agent at a merchant receiving system 128 receives the request from the payor and submits it to the Transaction Management System 122. Next, at Step 1004, the wireless carrier that holds the payor's account balance may be identified.

Next, at Step 1008, the identity of the payee and the payor's sending account may be verified with the carrier system 124 to determine whether the payee may have been previously associated with the payor's sending account and that the payor's sending account is a valid account. In certain embodiments, the payee may not be linked to and/or associated with the sending account. For example, the funds transfer module 1000 may perform the verification step 1008 by creating a message to the carrier system 124 requesting that the carrier system 124 send confirmation to the funds transfer module 1000 that the payor's sending account is valid and that the payee has been previously associated with the payor's sending account. In certain embodiments, all or part of the confirmation request may be sent to a party or system other than the carrier. In various embodiments, this message may be sent as one message, as described above, or as two messages (e.g., one message requesting verification of the payor's account and another message requesting verification of the association of the payee with the payor's account).

In addition, at Step 1004, the funds transfer module 1000 may verify whether the payor's sending account has sufficient funds to make the requested transfer to the payee. According to one embodiment, a billing engine of the carrier system 124 may store the account balances for payors having sending accounts with the carrier, and the funds transfer module 1000 may generate and transmit a message to the billing engine requesting that the billing engine confirm that the payor's sending account has sufficient funds.

FIG. 10 shows Step 1010 as occurring after Step 1008, but in alternative embodiments, Step 1008 may occur prior to or simultaneously with Step 306. For example, in an embodiment (not shown) in which Steps 1008 and 1010 occur simultaneously, the funds transfer module 1000 may generate and transmit one message to the billing engine requesting the billing engine to confirm that the payor's sending account is valid and the payor's sending account has sufficient funds.

According to various embodiments, in response to receiving confirmation from the carrier system 124 that the payor's sending account is valid, the funds transfer module 1000 may generate and transmit a debit message to the carrier system 124 instructing the carrier system 124 to decrement the sending account for the amount to be transferred to the payee, shown as Step 1012. In one embodiment, the step of generating and transmitting a debit message may occur as a separate and subsequent step from verifying that the sending account has sufficient funds to make the transfer (Step 1010), as shown in FIG. 10. However, in an alternative embodiment (not shown), the funds transfer module 1000 may generate and transmit a message to the carrier system 124 requesting the carrier system 124 to (1) verify that the sending account has sufficient funds to make the transfer, and (2) if verified, decrement the sending account for the amount of the funds to be transferred. In this embodiment, Step 1012 may occur simultaneously with Step 1010. In addition, according to yet another embodiment, Step 1012 may occur simultaneously with Steps 1010 and 1008.

According to various embodiments, the funds transfer module 1000 may then generate and transmit a transaction message that may ultimately be presented by the payee to the receiving system 128 to collect the funds transferred, shown in Step 1014. In various embodiments, for example, the transaction message may include a number, an alpha-numeric code, or textual message. The transaction message may include a password. The transaction message may include at least one of a transaction number and a password. Furthermore, in one embodiment, the transaction message may be transmitted from the funds transfer module 1000 to the payor, and the payor may be responsible for transmitting or otherwise communicating the transaction number to the payee. In another embodiment, the transaction message may be transmitted from the funds transfer module 1000 to the payor and the payee. And, in yet another embodiment, the transaction message may be transmitted from the funds transfer module 1000 to the payor, the payee, and the receiving system 128. In addition, in various embodiments, the transaction message may be transferred to the receiving system 128 over the banking network 708 or another network (e.g., similar to a credit card authorization), and in other various embodiments, the transaction message is transferred over a proprietary network 708, the Internet, a wireless network 708, another network, private communication network 708, a virtual private network 708, a landline, a proprietary communication network 708, and the like. Furthermore, according to various embodiments, the transmission of the transaction message from the funds transfer module 1000 to the payee may occur over a wireless network 708, another network, the Internet, or a private network 708.

To obtain the funds from the receiving system 128, the payee may present the transaction message to the receiving system 128, and the receiving system 128 may verify the transaction message. In one embodiment, the verification of the transaction number by the receiving system 128 may be accomplished by sending the transaction message (or a portion thereof) to the Transaction Management System 122 for verification. In another embodiment, the verification of the transaction number may be accomplished by comparing the transaction message presented by the payee to a transaction message received by the receiving system 128 from the Transaction Management System 122.

In response to verifying the transaction message, the receiving system 128 may provide the funds to the payee. According to an alternative embodiment in which the receiving system 128 is a wireless telephone carrier, the payee may elect to have the funds provided directly to the payee or credited to the payee's wireless carrier account. Similarly, in another embodiment in which the receiving system 128 may be a merchant, the payee may elect to have the funds provided directly to the payee or credited towards a purchase of goods or services from the merchant. In another embodiment, the payee may elect to have funds provided to a bank, a stored value card, or the like.

Furthermore, according to various other embodiments, the transaction message may be transmitted only to the payee, and the receiving system 128 may request verification of the transaction message from the funds transfer module 1000 in response to receiving the transaction message from the payee. According to one embodiment, the process of verifying the transaction message may be similar to the process of requesting authorization of a transaction for purchases made with a credit or debit card using the banking network 708 or another network.

Settlement between the receiving system 128 and the carrier system 124 may occur periodically for transactions that were authorized within a particular time period (e.g., hourly, daily, every 48 hours, weekly, every 90 days, every 180 days, in real time, and the like). In certain embodiments, a shorter settlement period may be associated with a higher transaction fee. In various embodiments, the funds transfer module 1000 may consolidate settlement requests for each carrier system 124 into a batch file and transmits each batch file to the respective carrier system 124, shown as Step 1018. At Step 1020, the transaction may be cleared. According to one embodiment, the carrier system's 124 bank may transmit the funds requested for settlement to a bank of the appropriate receiving system 128 via the banking network 708 or another network via ACH or EFT, for example. In one embodiment in which the Transaction Management System 122 is separate from the carrier's system 124, the Transaction Management System 122 may receive a fee (e.g., flat fee, exchange rate spread, exchange rate markup, percentage of amount of funds transferred as a result of the processing handled by the Transaction Management System 122) upon settlement from the carrier system 124 for processing transfer requests. In certain embodiments, certain fees may be shared with a carrier and/or a merchant. The Transaction Management System 122 may collect or oversee the collection of the entire fee which is shared.

After the settlement request is generated and sent to the carrier system 124, the funds transfer module 1000 may verify that the funds are received by the receiving system 128, shown in Step 1022. In various embodiments, the funds transfer module 300 may send a message to the receiving system 128 requesting the receiving system 128 to verify that funds have been received. In other embodiments, the funds transfer module 1000 may send a message to the carrier system 124 requesting verification that the receiving system 128 received the funds. In yet another embodiment, the funds transfer module 1000 may verify that the funds have been received by the receiving system 128 by receiving and reviewing statements provided by the receiving system 128 and/or the carrier system 124 itemizing settlement transactions that occurred.

The embodiments described above for FIGS. 1 and 10 describe a payor as initiating a request to transfer funds to a payee. However, in various other embodiments, the payee may initiate the request to transfer funds from the payor's sending account to the payee. In particular, according to one embodiment, the payee may generate and send a request to transfer funds to the Transaction Management System 122. In response to receiving the transfer request, the Transaction Management System 122, according to one embodiment, may generate and send to the payor a request for the payor to confirm that the transfer request should be processed. If the payor approves the request, the payor may send a message to the Transaction Management System 122 approving the transfer, which allows the request to be processed. However, if the payor does not approve the request, the payor may send a message to the Transaction Management System 122 denying the request, which may prevent the request from being processed.

In yet another embodiment, the payee may not be pre-associated with the payor's sending account prior to a payor or payee generating a transfer request. In such an embodiment, the payor or payee may provide the set-up information to the Transaction Management System 122 (which is described above in relation to Step 902 of FIG. 7) along with the transfer request (which is described above in relation to Step 1002 in FIG. 10), and the Transaction Management System 122 may execute the account setup module 900 (at least through Steps 910), and then execute the funds transfer module 1000, according to a particular embodiment.

Furthermore, in the embodiments described, funds are transferred from a sending account to a payee. However, it is to be understood that in alternative embodiments, the funds may be transferred to a payee from a pre-paid land-line telephone account, a post-paid wireless telephone account, a post-paid land-line telephone account, or the like. In one embodiment, for example, the amount transferred from the post-paid wireless telephone account or the post-paid land-line telephone account may be billed to the payor periodically, such as with the payor's bill for telephone usage, digital media purchases, and the like. In addition, in one embodiment, a credit limit may be associated with the post-paid wireless telephone account or the post-paid land-line telephone account, and in response to receiving a request to transfer funds from the post-paid accounts to a payee, the transaction management server may verify that the funds requested do not exceed the available credit limit.

In an alternate embodiment, the funds transfer module 1000 may provide a Transaction Management System 122 for managing transfers of funds from a sending account to a payee. The Transaction Management System 122 may be adapted to allow the payee to redeem funds by entering a transaction number associated with a verified fund transfer request. The funds transfer module 300 may also be adapted to process requests to transfer funds from the sending account to the payee, where the funds transfer module is part of the Transaction Management System 122.

FIG. 12 illustrates a flow diagram of a reporting module 1200 according to various embodiments of the invention. Beginning at Step 1202, the reporting module 1200 receives and stores transaction data related to transfer transactions processed by the funds transfer module 1000 of the Transaction Management System 122. In various embodiments, exemplary transaction data for a particular transaction may be one or more of the following: a carrier holding the payor's sending account, an amount of funds transferred, a receiving system 128 that received the funds for the payee, a date and time that the transaction message was transmitted, a date and time that the settlement request was sent to the carrier system 124, a date and time that the settlement was verified, amount verified at settlement, transaction number, password, administrative data, and the like.

Next, in Step 1204, the reporting module 1200 may receive a request from the carrier system 124 or the receiving system 128 to retrieve stored data related to transactions in which the carrier system 124 or the receiving system 128 was a party. In various embodiments, the carrier system 124 or receiving system 128 may access the reporting module 1200 via a secure connection over the Internet (e.g., via a TCP/IP socket session or VPN session) or a private network 708 (e.g., proprietary network). In addition, in one embodiment, the carrier system 124 and receiving system 128 may, for example, request a certain amount of data from the reporting module 1200 (e.g., query the reporting module 1200 for data collected (or transactions occurring) within a particular time period or involving payor sending accounts having a particular area code associated with the payors' phone number) using a standard query message (e.g., My SQL or Crystal Report Writer) or a customized query message.

In response to receiving the request to retrieve stored data, the reporting module 1200 may gather the requested data and transmit it to the system 128, 124 making the retrieval request, which is shown in Step 1208. In various embodiments, the gathered data may be transmitted as raw data (not formatted) or arranged in a particular format. In other various embodiments, the format may be a format requested by the carrier system 124 or receiving system 128 or it may be set by the reporting module 1200. In addition, in yet another embodiment, the various systems 128, 124 may instruct the reporting module 1200 to format the data transmitted to each system 128, 124 into a format that is specific to each system 128, 124, and these formatting preferences may be stored by the reporting module 1200 on the Transaction Management System 122. In an embodiment, the report may be a daily report of all the funds transferred broken down by carrier, by recipient and the like. In an embodiment, the report may be a compliance report, detailing suspicious activity in a format suitable for submission to lay enforcement and regulatory agencies. Furthermore, in various embodiments, the data transmitted to the systems 128, 124 may be downloaded via a secure Internet or private network 708 connection (e.g., using file transfer protocol (FTP)).

In various other embodiments of the invention (not shown), the reporting module 1200 may be adapted to transfer transaction data to the carrier systems 124 and the receiving systems 128 without receiving a request from the systems 128, 124. For example, in one embodiment, the reporting module 1200 may be adapted to generate reports for each system 128, 124 periodically (e.g., hourly, daily, weekly, monthly, every 90 days, every 180 days, in real time, or the like). In another embodiment, the reporting module 1200 is adapted to generate reports for each system 128, 124 in response to the funds transfer module 1000 receiving verification that the funds were received by the receiving system 128 in Step 1022 of FIG. 10.

In various embodiments of the invention, the systems 128, 124 may use the transaction data provided by the reporting module 1200 to reconcile their transaction data and for other financial purposes (e.g., financial accounting, reporting on financial statements, auditing, and the like).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

1-91. (canceled)

92. A method, comprising:
hosting a transaction management system, the transaction management system adapted to receive a funds transfer request from a holder of a sending account with a phone service provider;
accepting a funds transfer request;
identifying a relevant phone service provider;
determining the availability of the funds with the phone service provider;
confirming the desire of the holder to transfer funds; and
providing an indication of the availability of the funds for transfer.

93. The method of claim 92 wherein providing an indication of availability of the funds for transfer includes providing an indication to a point-of-interaction operator.

94. The method of claim 92 wherein providing an indication of availability of the funds for transfer includes providing an indication to a point-of-interaction operator and providing the indication includes providing a transaction number to a payee that is adapted to be submitted by the payee to the point-of-interaction operator.

95. The method of claim 92 wherein the sending account is selected from the group consisting of a pre-paid wireless telephone account, a pre-paid telephone account, a pre-paid wireless account, a pre-paid land-line telephone account, a pre-paid calling card, a pre-paid stored value card, a pre-paid stored value card associated with a mobile phone, a pre-paid stored value card not associated with a mobile phone, a post-paid wireless telephone account, a post-paid land-line telephone account, a credit card account, a debit card account, an account associated with a mobile phone, an account is associated with a landline and an account is associated with a stored value card.

96. The method of claim 92 wherein the sending account is selected from the group consisting of a pre-paid wireless telephone account and a post-paid wireless telephone account.

97. The method of claim 92 wherein a compliance assessment is performed prior to funds being transferred.

98. The method of claim 92 further comprising determining the association of the holder and the sending account and identifying a relevant payee and determining the association of the payee and the sending account.

99. The method of claim 92 further comprising determining the association of the holder and the sending account and identifying a relevant payee and determining the association of the name of the payee and a telephone number associated with the sending account.

100. The method of claim 92 wherein compliance with at least one of volume controls and velocity controls is assessed prior to funds being transferred.

101. The method of claim 92 further comprising providing an electronic receipt to at least one of the holder and a relevant payee.

102. The method of claim 92 further comprising providing an electronic receipt in the form of a text message to at least one of the holder and a relevant payee.

103. The method of claim 92 further comprising providing a confirmation to the holder once a relevant payee has received at least a portion of the funds.

104. A system for processing a request to associate a payee with a sending account of a payor and a request to transfer funds to said payee from said sending account, wherein said request to associate said payee with said sending account and said request to transfer funds to said payee are received over a communication network, and wherein said communication network is selected from the group consisting of: a wireless network, another network, the Internet, a banking network, a private communication network, a virtual private network, a landline and a proprietary communication network

105. The system of claim 104 wherein the sending account is selected from the group consisting of a pre-paid wireless telephone account, a pre-paid telephone account, a pre-paid wireless account, a pre-paid land-line telephone account, a pre-paid calling card, a pre-paid stored value card, a pre-paid stored value card associated with a mobile phone, a pre-paid stored value card not associated with a mobile phone, a post-paid wireless telephone account, a post-paid land-line telephone account, a credit card account, a debit card account, an account associated with a mobile phone, an account is associated with a landline and an account is associated with a stored value card.

106. The system of claim 104 wherein the sending account is selected from the group consisting of a pre-paid wireless telephone account and a post-paid wireless telephone account.

107. The system of claim 104 wherein a compliance assessment is performed prior to associating the payee with the sending account.

108. The system of claim 104 wherein compliance with at least one of volume controls and velocity controls is assessed prior to associating the payee with the sending account.

109. The system of claim 104 further comprising verifying the association of the payor and the sending account prior to associating the payee with the sending account.

110. A funds transfer process, comprising:
receiving a request to transfer funds;
identifying the wireless carrier that holds the payor's account balance;
verifying that a payor's account is valid and that a payee is associated with payor's account;
verifying that the amount requested is available in the payor's sending account;
generating and transmitting a debit message to decrement the sending account;
generating and transmitting a transaction message;
generating and transmitting a settlement request to carrier system;
clearing the transaction; and
verifying that funds are received by a receiving system.

111. The funds transfer process of claim 110 wherein the request to transfer funds includes at least one of the identity of the payor's sending account, the amount of funds to be transferred, the identity of the payee and information specifying the receiving system.

112. The funds transfer process of claim 110 wherein the sending account is selected from the group consisting of a pre-paid wireless telephone account, a pre-paid telephone account, a pre-paid wireless account, a pre-paid land-line telephone account, a pre-paid calling card, a pre-paid stored value card, a pre-paid stored value card associated with a mobile phone, a pre-paid stored value card not associated with a mobile phone, a post-paid wireless telephone account, a post-paid land-line telephone account, a credit card account, a debit card account, an account associated with a mobile phone, an account is associated with a landline and an account is associated with a stored value card.

113. The funds transfer process of claim 110 wherein the sending account is selected from the group consisting of a pre-paid wireless telephone account and a post-paid wireless telephone account.

114. The funds transfer process of claim 110 wherein the transaction message may include at least one of a number, an alpha-numeric code and textual message.

115. The funds transfer process of claim 110 wherein the transaction message includes at least one of a transaction number and a password.

116. The funds transfer process of claim 110 wherein the process is performed by the funds transfer module.

117. The funds transfer process of claim 110 wherein a compliance assessment is performed prior to funds being provided to the payee.

118. The funds transfer process of claim 110 wherein verifying that a payee is associated with payor's account includes determining the association of the payee and the payor's account.

119. The funds transfer process of claim 110 wherein verifying that a payee is associated with payor's account includes determining the association of the name of the payee and a telephone number associated with the payor's account.

120. The funds transfer process of claim 110 wherein verifying that the payor's account is valid includes verification of a password.

121. The funds transfer process of claim 110 further comprising verifying the identity of the payee prior to providing funds to the receiving system.

122. The funds transfer process of claim 110 wherein compliance with at least one of volume controls and velocity controls is assessed prior to funds being provided to the payee.

123. The funds transfer process of claim 110 further comprising providing an electronic receipt to at least one of the payor and the payee.

124. The funds transfer process of claim 110 further comprising providing an electronic receipt in the form of a text message to at least one of the payor and the payee.

125. The funds transfer process of claim 110 further comprising providing a confirmation to the payor once the payee has received at least a portion of the funds.
